(19) United States
(12) Patent Application Publication
(10) Pub. No.: US 2015/0159717 A1
(43) Pub. Date: Jun. 11, 2015

(54) NI-CU PLATED HIGH-CARBON STEEL WIRE FOR SPRINGS AND METHOD OF MANUFACTURING THE SAME

(71) Applicant: Kiswire Ltd., Busan (KR)

(72) Inventors: Jin Young Jung, Gyeongsangbuk-do (KR); Lee Seok Hong, Busan (KR); Sung Young Lim, Busan (KR)

(73) Assignee: Kiswire Ltd., Busan (KR)

(21) Appl. No.: 14/412,807

(22) PCT Filed: Jul. 4, 2013
(86) PCT No.: PCT/KR2013/005958

§ 371 Date: Jan. 5, 2015

(30) Foreign Application Priority Data
Jul. 4, 2012 (KR) 10-2012-0072870

(51) Int. Cl. F16F 1/02; C23C 18/38; C23C 18/32; B32B 15/01; C23C 18/16

(52) U.S. Cl. CPC F16F 1/021; B32B 15/015; C23C 18/1637; C23C 18/32; C23C 18/38

(57) ABSTRACT

Provided is a nickel (Ni)-copper (Cu) plated high-carbon steel wire for springs. The Ni—Cu plated high-carbon steel wire includes a core wire that includes a high-carbon steel wire; and a Ni-plating layer and a Cu player which are sequentially plated on a surface of the core wire and then are drawn.

### TECHNICAL FIELD

The present invention relates to a nickel (Ni)-copper (Cu) plated high-carbon steel wire for springs and a method of manufacturing the same, and more particularly, to a Ni—Cu plated high-carbon steel wire for springs which increases a drawing speed by ensuring sufficient drawing lubrication and improves surface quality and corrosion resistance of a steel wire, and a method of manufacturing the Ni—Cu plated high-carbon steel wire for springs.

### BACKGROUND ART

A conventional high-carbon steel wire for springs has problems in that a drawing speed is low because sufficient drawing lubrication is not ensured, and defects such as a die mark often occur on a surface.

When a stainless steel wire is used as a core wire for ultra-fine springs whose thickness is 0.2 mm or less, nickel (Ni) plating may be used. However, in this case, high drawability is not ensured and problems such as cracks often occur during drawing.

Although KR 10-0297400 discloses a Ni plated high-carbon steel wire wherein a high-carbon steel wire instead of a stainless steel wire is used and Ni plating is used, even the Ni plated high-carbon steel wire may not ensure sufficient drawability during drawing.

### DISCLOSURE OF INVENTION

### Technical Problem

The present invention provides a nickel (Ni)-copper (Cu) plated high-carbon steel wire for springs which increases a drawing speed by ensuring sufficient drawing lubrication and improves surface quality and corrosion resistance, and a method of manufacturing the Ni—Cu plated high-carbon steel wire for springs.

### Solution to Problem

According to an aspect of the present invention, there is provided a nickel(Ni)-copper(Cu) plated high-carbon steel wire for springs, the Ni—Cu plated high-carbon steel wire including: a core wire that is formed by using a high-carbon steel wire; a Ni-plating layer and a Cu-plating layer which are sequentially plated on a surface of the core wire and then are drawn.

A thickness of the Ni-plating layer may be equal to or greater than a square of a thickness of the Cu-plating layer.

A total thickness obtained by summing a thickness of the Ni-plating layer and the Cu-plating layer may be equal to or greater than 0.1 μm and equal to or less than 5 μm.

The Ni-plating layer and the Cu-plating layer may be thermally treated to diffuse the Ni-plating layer and the Cu-plating layer and to form a Ni—Cu alloy layer and then are drawn, wherein a content of Ni of the Ni—Cu alloy layer is equal to or greater than 60%.

The core wire on which the Ni-plating layer and the Cu-plating layer are formed may be thermally treated and drawn to diffuse the Ni-plating layer and the Cu-plating layer and to form a Ni—Cu alloy layer, wherein a content of Ni in the Ni—Cu alloy layer is equal to or greater than 60%.

After being drawn, the core wire on which the Ni-plating layer and the Cu-plating layer are formed may be thermally treated to diffuse the Ni-plating layer and the Cu-plating layer and to form a Ni—Cu alloy layer, wherein a content of Ni in the Ni—Cu alloy layer is equal to or greater than 60%.

The thermal treatment may be performed at a temperature ranging from 200° C. to 500° C.

According to another aspect of the present invention, there is provided a method of manufacturing a nickel(Ni)-copper(Cu) plated high-carbon steel wire for springs, the method including: manufacturing a core wire by using a high-carbon steel wire; forming a Ni-plating layer on the core wire; forming a Cu-plating layer on the Ni-plating layer; and after the forming of the Ni-plating layer and the Cu-plating layer, performing drawing.

A thickness of the Ni-plating layer may be equal to or greater than a square of a thickness of the Cu-plating layer.

A total thickness obtained by summing a thickness of the Ni-plating layer and a thickness of the Cu-plating layer may be equal to or greater than 0.1 μm and equal to or less than 5 μm.

Before the performing of the drawing, the method may include thermally treating the Ni-plating layer and the Cu-plating layer to diffuse the Ni-plating layer and the Cu-plating layer and to form a Ni—Cu alloy layer, wherein a content of Ni in the Ni—Cu alloy layer is equal to or greater than 60%.

The core wire on which the Ni-plating layer and the Cu-plating layer are formed may be thermally treated and drawn to diffuse the Ni-plating layer and the Cu-plating layer and to form a Ni—Cu alloy layer, wherein a content of Ni in the Ni—Cu alloy layer is equal to or greater than 60%.

After the performing of the drawing, the method may include thermally treating the core wire on which the Ni-plating layer and the Cu-plating layer are formed to diffuse the Ni-plating layer and the Cu-plating layer and to form a Ni—Cu alloy layer, wherein a content of Ni in the Ni—Cu alloy layer is equal to or greater than 60%.

The thermal treatment may be performed at a temperature ranging from 200° C. to 500° C.

### Advantageous Effects of Invention

The present invention provides a nickel (Ni)-copper (Cu) plated high-carbon steel wire for springs which increases a drawing speed by ensuring sufficient drawing lubrication and improves surface quality and corrosion resistance, and a method of manufacturing the Ni—Cu plated high-carbon steel wire for springs.

### BRIEF DESCRIPTION OF DRAWINGS

FIG. 1 is a cross-sectional view illustrating a nickel (Ni)-copper (Cu) plated high-carbon steel wire for springs, according to an embodiment of the present invention;

FIG. 2 is a cross-sectional view illustrating a Ni—Cu plated high-carbon steel wire for springs, according to another embodiment of the present invention;

FIG. 3 is a flowchart illustrating a method of manufacturing a Ni—Cu plated high-carbon steel wire for springs, according to an embodiment of the present invention;

FIG. 4 is a flowchart illustrating a method of manufacturing a Ni—Cu plated high-carbon steel wire for springs, according to another embodiment of the present invention;

FIG. 5 is a flowchart illustrating a method of manufacturing a Ni—Cu plated high-carbon steel wire for springs, according to another embodiment of the present invention; and

FIG. 6 is a flowchart illustrating a method of manufacturing a Ni—Cu plated high-carbon steel wire for springs, according to another embodiment of the present invention.

### BEST MODE FOR CARRYING OUT THE INVENTION

The present invention will now be described more fully with reference to the accompanying drawings, in which exemplary embodiments of the invention are shown.

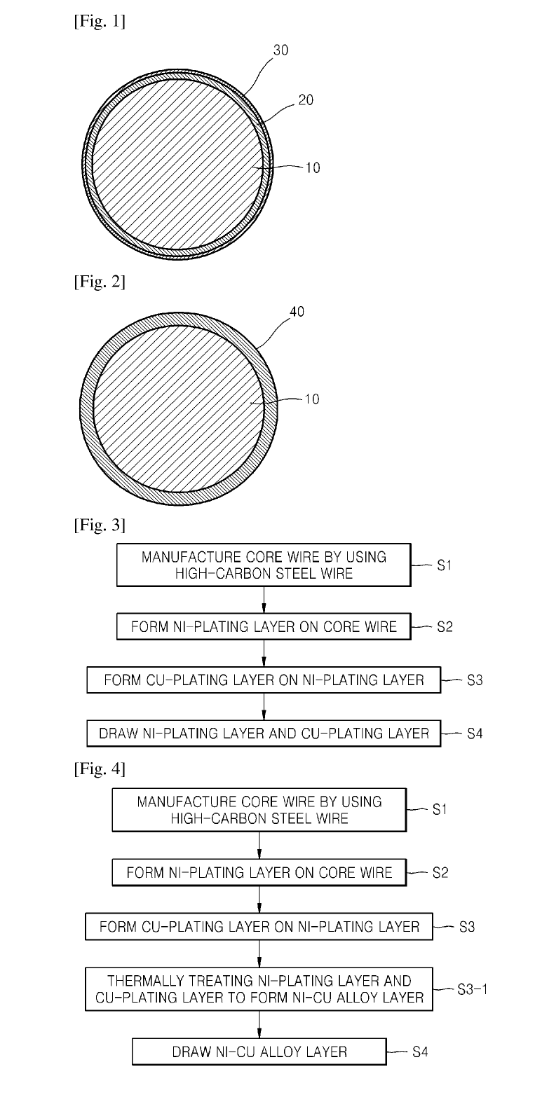

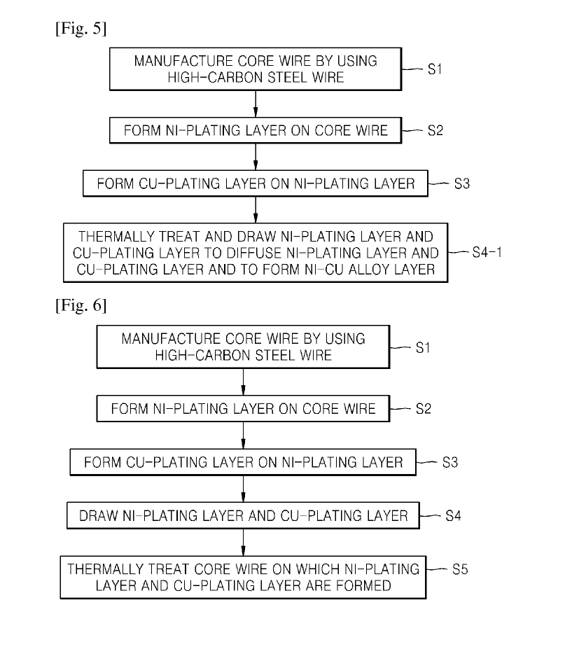

FIG. 1 is a cross-sectional view illustrating a nickel (Ni)-copper (Cu) plated high-carbon steel wire for springs, according to an embodiment of the present invention. FIG. 2 is a cross-sectional view illustrating a Ni—Cu plated high-carbon steel wire for springs, according to another embodiment of the present invention. FIG. 3 is a flowchart illustrating a method of manufacturing a Ni—Cu plated high-carbon steel wire for springs, according to an embodiment of the present invention. FIG. 4 is a flowchart illustrating a method of manufacturing a Ni—Cu plated high-carbon steel wire for springs, according to another embodiment of the present invention. FIG. 5 is a flowchart illustrating a method of manufacturing a Ni—Cu plated high-carbon steel wire for springs, according to another embodiment of the present invention. FIG. 6 is a flowchart illustrating a method of manufacturing a Ni—Cu plated high-carbon steel wire for springs, according to another embodiment of the present invention.

Referring to FIG. 1, the Ni—Cu plated high-carbon steel wire for springs includes a core wire 10, a Ni-plating layer 20, and a Cu-plating layer 30.

The core wire 10 is manufactured by using a high-carbon steel wire. In FIG. 1, the core wire is a high-carbon steel wire in which a content of carbon (C) is equal to or greater than 0.8 weight %.

The Ni-plating layer 20 and the Cu-plating layer 30 which are essential parts in the present embodiment are formed by plating the Ni-plating layer 20 on an outer circumferential surface of the core wire 10 and then plating the Cu-plating layer 30. After the Ni-plating layer 20 and the Cu-plating layer 30 are plated, drawing is performed.

The Ni-plating layer 20 is provided in order to improve corrosion resistance of the Ni—Cu plated high-carbon steel wire for springs. The Cu-plating layer 30 is provided in order to increase a drawing speed by ensuring sufficient lubrication during drawing and in order to improve surface quality of the Ni—Cu plated high-carbon steel wire for springs.

In the present embodiment, a thickness of the Ni-plating layer 20 is equal to or greater than a square of a thickness of the Cu-plating layer 30, and a total thickness obtained by summing a thickness of the Ni-plating layer 20 and a thickness of the Cu-plating layer 30 is equal to or greater than 0.1 μm and equal to or less than 5 μm.

When a thickness of the Ni-plating layer 20 is less than a square of a thickness of the Cu-plating layer 30, corrosion resistance of the Ni—Cu plated high-carbon steel wire is degraded. When a total thickness obtained by summing a thickness of the Ni-plating layer 20 and a thickness of the Cu-plating layer 30 is less than 0.1 μm, corrosion resistance is degraded. When a total thickness obtained by summing a thickness of the Ni-plating layer 20 and a thickness of the Cu-plating layer 30 is greater than 5 μm, manufacturing costs are increased due to the excessive total thickness.

Alternatively, the Ni-plating layer 20 and the Cu-plating layer 30 may be formed and then thermally treated to form one Ni—Cu alloy layer.

Referring to FIG. 2, the Ni-plating layer 20 and the Cu-plating layer 30 are sequentially plated on an outer circumferential surface of the core wire 10 and then thermally treated to diffuse the Ni-plating layer 20 and the Cu-plating layer 30 and to form a Ni—Cu alloy layer 40. After the Ni—Cu alloy layer 40 is formed, drawing is performed.

In the present embodiment, the thermal treatment is performed at a temperature ranging from 200° C. to 500° C. In the temperature range, the Ni-plating layer 20 and the Cu-plating layer 30 may be diffused. A time taken to perform the thermal treatment is appropriately adjusted according to the temperature range. A time taken to perform the thermal treatment at a relatively high temperature is less than a time taken to perform the thermal treatment at a relatively low temperature.

In the present embodiment, a content of Ni in the Ni—Cu alloy layer 40 formed by performing the thermal treatment is equal to or greater than 60% based on a total weight of the Ni—Cu alloy layer 40. It is found that when a content of Ni is equal to or greater than 60%, corrosion resistance is improved.

Also, in the present embodiment, a thickness of the Ni—Cu alloy layer 40 is equal to or greater than 0.1 μm and equal to or less than 5 μm, like a total thickness obtained by summing a thickness of the Ni-plating layer 20 and a thickness of the Cu-plating layer 30.

When a thickness of the Ni—Cu alloy layer 40 is less than 0.1 μm, corrosion resistance is degraded. When a thickness of the Ni—Cu alloy layer 40 is greater than 5 μm, manufacturing costs are increased due to the excessive thickness.

Alternatively, the core 10 on which the Ni-plating layer 20 and the Cu-plating layer 30 are formed may be simultaneously thermally treated and drawn to diffuse the Ni-plating layer 20 and the Cu-plating layer 30 and to form the Ni—Cu alloy layer 40. That is, drawing and thermal treatment may be simultaneously performed.

In this case, the thermal treatment is performed at a temperature ranging from 200° C. to 500° C. Also, a content of Ni in the Ni—Cu alloy layer 40 is equal to or greater than 60% based on a total weight of the Ni—Cu alloy layer 40.

In the present embodiment, an operation and an effect of a temperature range of the thermal treatment, a thickness of the Ni—Cu alloy layer 40, and a standard for a content of Ni in the Ni—Cu alloy layer 40 are the same as those described above, and thus a detailed explanation thereof will not be given.

Alternatively, the core wire 10 on which the Ni-plating layer 20 and the Cu-plating layer 30 are formed may be drawn, and when drawing is completed to diffuse the Ni-plating layer 20 and the Cu-plating layer 30 and to form the Ni—Cu alloy layer 40, thermal treatment may be performed. That is, thermal treatment may be performed after drawing is performed.

In this case, the thermal treatment is performed at a temperature ranging from 200° C. to 500° C. Also, a content of Ni in the Ni—Cu alloy layer 40 is equal to or greater than 60% based on a total weight of the Ni—Cu alloy layer 40.

In the present embodiment, an operation and an effect of a temperature range of the thermal treatment, a thickness of the Ni—Cu alloy layer 40, and a standard for a content of Ni in the Ni—Cu alloy layer 40 are the same as those described above, and thus a detailed explanation thereof will not be given.

An operation and an effect of the present invention will be explained in detail by using an experimental example to which the present invention is applied.

Referring to Table 1, 12 samples were tested in the experimental example. The sample 1 corresponds to a case where the Ni-plating layer 20 and the Cu-plating layer 30 are not formed. The samples 2 through 12 correspond to cases where the Ni-plating layer 20 and the Cu-plating layer 30 are sequentially stacked on an outer circumferential surface of the core wire 10 and then are thermally treated at a predetermined temperature.

In the samples 2 through 12, a total plating thickness refers to a sum of a thickness of the Ni-plating layer 20 and a thickness of the Cu-plating layer 30, and a content of Ni in an alloy layer after thermal treatment is expressed in weight % based on a total weight of the alloy layer.

In the experimental example, a 5.5 mm high-carbon steel wire containing 0.82 weight % C, 0.2 weight % silicon (Si), 0.4 weight % manganese (Mn), 0.015 weight % phosphorus (P), and 0.015 weight % sulfur (S) was used as the core wire 10, and the high-carbon steel wire was subjected to inline acid cleaning and phosphate coating and then was first drawn to have a diameter of 2.4 mm.

Next, the high-carbon steel wire was heated at 1000° C., was subjected to lead patenting at 560° C. to have a pearlite structure, was subjected to second acid cleaning and phosphate coating, and was second drawn to have a diameter of 0.6 mm.

The high-carbon steel wire second drawn to have a diameter of 0.6 mm was subjected to lead patenting at 560° C. again, and was subjected to acid cleaning, and then the Ni-plating layer 20 and the Cu-plating layer 30 were sequentially formed.

Next, the core wire 10 on which the Ni-plating layer 20 and the Cu-plating layer 30 were formed was finally drawn to have a diameter of 0.1 mm. In this case, a drawing speed of the sample 1 was 100 m/min, a drawing speed of each of the samples 2 through 12 was 500 m/min, and a wet drawing machine using 22 dies was used.

After the final drawing, the core wire 10 was thermally treated at 500° C. by additionally using high-frequency waves to diffuse the Ni-plating layer 20 and the Cu-plating layer 30 and to form the Ni—Cu alloy layer 40.

TABLE 1

| | | | Ni- | Cu- | Total | Ratio of thickness of Ni-plating | Content of Ni | Formability | Corrosion |
|---|---|---|---|---|---|---|---|---|---|
| | | | plating | plating | plating | layer to thickness of Cu-plating | in alloy layer | (surface | resistance |
| | Wire | Drawing | layer | layer | layer | layer (thickness of Ni-plating | after thermal | properties | (salt water |
| Sample | diameter | speed | thickness | thickness | thickness | layer/thickness of Cu-plating | treatment | of steel | spray time/ |
| No. | (mm) | (m/min) | (μm) | (μm) | (μm) | layer) | (weight %) | wire) | minute) |
| 1 | 0.1 | 100 | 0 | 0 | 0 | — | 0 | bad | 5/bad |
| 2 | 0.1 | 500 | 0.05 | 0.02 | 0.07 | 2.5 | 71.4 | bad | 6/bad |
| 3 | 0.1 | 500 | 0.10 | 0.04 | 0.14 | 2.5 | 71.4 | Good | 15/good |
| 4 | 0.1 | 500 | 0.15 | 0.12 | 0.27 | 1.3 | 55.6 | Good | 9/bad |
| 5 | 0.1 | 500 | 0.20 | 0.15 | 0.35 | 1.3 | 57.1 | Good | 11/bad |
| 6 | 0.1 | 500 | 0.23 | 0.11 | 0.34 | 2.1 | 67.6 | Good | 20/good |
| 7 | 0.1 | 500 | 0.35 | 0.15 | 0.5 | 2.3 | 70.0 | Good | 25/good |
| 8 | 0.1 | 500 | 0.46 | 0.21 | 0.67 | 2.2 | 68.7 | Good | 30/good |
| 9 | 0.1 | 500 | 1.20 | 0.50 | 1.7 | 2.4 | 70.6 | Good | 32/good |
| 10 | 0.1 | 500 | 1.50 | 0.70 | 2.2 | 2.1 | 68.2 | Good | 35/good |
| 11 | 0.1 | 500 | 2.50 | 1.10 | 3.6 | 2.3 | 69.4 | Good | 39/good |
| 12 | 0.1 | 500 | 3.50 | 1.20 | 4.7 | 2.9 | 74.5 | Good | 45/good |

It is found that since the Cu-plating layer 30 or the Ni—Cu alloy layer 40 was provided, a soft plating layer was formed on an outer circumferential surface of the core wire 10, drawing was performed at a drawing speed of 500 m/min which is higher than a drawing speed of a conventional non-plated high-carbon steel wire, and surface properties (formability) of the high-carbon steel wire were improved.

It is found from a result of the sample 2 that when a thickness of the Ni—Cu alloy layer 40 in the finally processed high-carbon steel wire was less than 0.1 μm, corrosion resistance was degraded.

Also, in the sample 4 and the sample 5, a ratio of a thickness of the Ni-plating layer 20 to a thickness of the Cu-plating layer 30 was 1.3. It is found from a result of the sample 4 and the sample 5 that when a ratio of a thickness of the Ni-plating layer 20 to a thickness of the Cu-plating layer 30 was less than 2.0, corrosion resistance was degraded.

Also, in the sample 4 and the sample 5, a content of Ni in the Ni—Cu alloy layer 40 after subsequent thermal treatment was 55.6 weight % and 57.1 weight %. It is found from a result of the sample 4 and the sample 5 that when a content of Ni was less than 60 weight %, corrosion resistance was bad.

A method of manufacturing a Ni—Cu plated high-carbon steel wire will be explained.

The method includes operation S1 in which the core wire 10 is manufactured by using a high-carbon steel wire, operation S2 in which the Ni-plating layer 20 is formed on the core wire 10, operation S3 in which the Cu-plating layer 30 is formed on the Ni-plating layer 20, and operation S4 in which the Ni-plating layer 20 and the Cu-plating layer 30 are drawn.

In the present embodiment, the core wire 10 is manufactured by using a high-carbon steel wire in which a content of C is equal to or greater than 0.8 weight %. Next, the Ni-plating layer 20 and the Cu-plating layer 30 are sequentially formed on an outer circumferential surface of the core wire 10. After the Ni-plating layer 20 and the Cu-plating layer 30 are formed, final drawing is performed.

In this case, a thickness of the Ni-plating layer 20 is equal to or greater than a square of a thickness of the Cu-plating layer 30 as described above for the Ni—Cu plated high-carbon steel wire. A total thickness obtained by summing a thickness of the Ni-plating layer 20 and a thickness of the Cu-plating layer 30 is equal to or greater than 0.1 μm and equal to or less than 5 μm.

An operation and an effect provided when a thickness of the Ni-plating layer 20 is equal to or greater than a square of a thickness of the Cu-plating layer 30 and a total thickness obtained by summing a thickness of the Ni-plating layer 20 and a thickness of the Cu-plating layer 30 is equal to or greater than 0.1 μm and equal to or less than 5 μm have already been described above, and thus a detailed explanation thereof will not be given.

Alternatively, the Ni-plating layer 20 and the Cu-plating layer 30 may be formed and then thermally treated to form one alloy layer.

In the present embodiment, after operations S1 through S3 are performed, operation S3-1 in which the Ni—Cu alloy layer 40 is formed is performed.

Operation S3-1 in which the Ni—Cu alloy layer 40 is formed is an operation in which the Ni-plating layer 20 and the Cu-plating layer 30 are thermally treated to diffuse the Ni-plating layer 20 and the Cu-plating layer 30 and to form the Ni—Cu alloy layer 40, before operation S4 in which drawing is performed.

In this case, a content of Ni in the Ni—Cu alloy layer 40 is equal to or greater than 60%. An operation and an effect provided when a content of Ni is equal to or greater than 60 weight % have already been described, and thus a detailed explanation thereof will not be given.

The thermal treatment is performed at a temperature ranging from 200° C. to 500° C. In the temperature range, the Ni-plating layer 20 and the Cu-plating layer 30 are diffused to form one Ni—Cu alloy layer 40.

An operation and an effect of the method according to the present embodiment are the same as those of the Ni—Cu plated high-carbon steel wire for springs, and thus a detailed explanation thereof will not be given.

Alternatively, the core wire 10 on which the Ni-plating layer 20 and the Cu-plating layer 30 are formed may be simultaneously thermally treated and drawn to diffuse the Ni-plating layer 20 and the Cu-plating layer 30 and to form the Ni—Cu alloy layer 40 in operation S4-1. That is, drawing and thermal treatment are simultaneously performed.

In this case, the thermal treatment is performed at a temperature ranging from 200° C. to 500° C. Also, a content of Ni in the Ni—Cu alloy layer 40 is equal to or greater than 60%. An operation and an effect of a content of Ni in the Ni—Cu alloy layer 40 and a temperature range of the thermal treatment have already been described, and thus a detailed explanation thereof will not be given.

Also, an operation and an effect of the method according to the present embodiment are the same as those of the Ni—Cu plated high-carbon steel wire for springs, and thus a detailed explanation thereof will not be given.

Alternatively, the core wire 10 on which the Ni-plating layer 20 and the Cu-plating layer 30 are formed may be drawn, and then the core wire 10 on which the Ni-plating layer 20 and the Cu-plating layer 30 are formed may be thermally treated to diffuse the Ni-plating layer 20 and the Cu-plating layer 30 and to form the Ni—Cu alloy layer 40 in operation S5. That is, drawing is performed and then thermal treatment is performed.

In this case, the thermal treatment is performed at a temperature ranging from 200° C. to 500° C. Also, a content of Ni in the Ni—Cu alloy layer 40 is equal to or greater than 60%. An operation and an effect of a content of Ni in the Ni—Cu alloy layer 40 and a temperature range of the thermal treatment have already been described, and thus a detailed explanation thereof will not be given.

Also, an operation and an effect of the method according to the present embodiment are the same as those of the Ni—Cu plated high-carbon steel wire for springs, and thus a detailed explanation thereof will not be given.

As described above, a Ni—Cu plated high-carbon steel wire for springs and a method of manufacturing the same according to the present invention improves corrosion resistance by using the Ni-plating layer 20, increases a drawing speed and reduces a manufacturing time by disposing the Cu-plating layer 30 on the Ni-plating layer 20 to improve lubrication, and improves surface quality of a final product. In particular, since a thickness of the Ni-plating layer 20 is equal to or greater than a square of a thickness of the Cu-plating layer 30, sufficient corrosion resistance is ensured by using the Ni-plating layer 20.

Also, when the Ni—Cu alloy layer 40 is formed by thermally treating the Ni-plating layer 20 and the Cu-plating layer 30, since a content of Ni is controlled to be equal to or greater than 60 weight % based on a total weight of the Ni—Cu alloy layer 40, sufficient corrosion resistance is ensured.

After the Ni—Cu plated high-carbon steel wire is first manufactured, gold plating may be subsequently performed. Since the Ni—Cu plated high-carbon steel with on which the Ni-plating layer 20 or the Ni—Cu alloy layer 40 is already formed is manufactured by being drawn, Ni under-plating for the gold plating may be omitted, thereby reducing manufacturing costs.

In a conventional non-plated high-carbon steel wire, the conventional non-plated high-carbon steel wire is formed and then gold plating is subsequently performed. In this case, Ni under-plating has to be performed. Since the Ni—Cu plated high-carbon steel wire for springs and the method according to the present invention may omit Ni under-plating when gold plating is subsequently performed, productivity may be improved and costs may be reduced.

A Ni—Cu plated high-carbon steel wire for springs and a method of manufacturing the same according to the present invention may increase a drawing speed by ensuring sufficient drawing lubrication and may improve surface quality and corrosion resistance.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A nickel (Ni)-copper (Cu) plated high-carbon steel wire for springs, the Ni—Cu plated high-carbon steel wire comprising:
a core wire that is formed by using a high-carbon steel wire;
a Ni-plating layer and a Cu-plating layer which are sequentially plated on a surface of the core wire and then are drawn.

2. The Ni—Cu plated high-carbon steel wire of claim 1, wherein a thickness of the Ni-plating layer is equal to or greater than a square of a thickness of the Cu-plating layer.

3. The Ni—Cu plated high-carbon steel wire of claim 1, wherein a total thickness obtained by summing a thickness of the Ni-plating layer and the Cu-plating layer is equal to or greater than 0.1 μm and equal to or less than 5 μm.

4. The Ni—Cu plated high-carbon steel wire of claim 1, wherein the Ni-plating layer and the Cu-plating layer are thermally treated to diffuse the Ni-plating layer and the Cu-plating layer and to form a Ni—Cu alloy layer and then are drawn,
wherein a content of Ni of the Ni—Cu alloy layer is equal to or greater than 60%.

5. The Ni—Cu plated high-carbon steel wire of claim 1, wherein the core wire on which the Ni-plating layer and the Cu-plating layer are formed is thermally treated and drawn to diffuse the Ni-plating layer and the Cu-plating layer and to form a Ni—Cu alloy layer,
wherein a content of Ni in the Ni—Cu alloy layer is equal to or greater than 60%.

6. The Ni—Cu plated high-carbon steel wire of claim 1, wherein after being drawn, the core wire on which the Ni-plating layer and the Cu-plating layer are formed is thermally treated to diffuse the Ni-plating layer and the Cu-plating layer and to form a Ni—Cu alloy layer,
wherein a content of Ni in the Ni—Cu alloy layer is equal to or greater than 60%.

7. The Ni—Cu plated high-carbon steel wire of claim 4, wherein the thermal treatment is performed at a temperature ranging from 200 to 500° C.

8. A method of manufacturing a nickel (Ni)-copper (Cu) plated high-carbon steel wire for springs, the method comprising:
manufacturing a core wire by using a high-carbon steel wire;
forming a Ni-plating layer on the core wire;
forming a Cu-plating layer on the Ni-plating layer; and
after the forming of the Ni-plating layer and the Cu-plating layer, performing drawing.

9. The method of claim 8, wherein a thickness of the Ni-plating layer is equal to or greater than a square of a thickness of the Cu-plating layer.

10. The method of claim 8, wherein a total thickness obtained by summing a thickness of the Ni-plating layer and a thickness of the Cu-plating layer is equal to or greater than 0.1 μm and equal to or less than 5 μm.

11. The method of claim 8, wherein before the performing of the drawing, the method comprises thermally treating the Ni-plating layer and the Cu-plating layer to diffuse the Ni-plating layer and the Cu-plating layer and to form a Ni—Cu alloy layer,
wherein a content of Ni in the Ni—Cu alloy layer is equal to or greater than 60%.

12. The method of claim 8, wherein the core wire on which the Ni-plating layer and the Cu-plating layer are formed is thermally treated and drawn to diffuse the Ni-plating layer and the Cu-plating layer and to form a Ni—Cu alloy layer,
wherein a content of Ni in the Ni—Cu alloy layer is equal to or greater than 60%.

13. The method of claim 8, wherein after the performing of the drawing, the method comprises thermally treating the core wire on which the Ni-plating layer and the Cu-plating layer are formed to diffuse the Ni-plating layer and the Cu-plating layer and to form a Ni—Cu alloy layer,
wherein a content of Ni in the Ni—Cu alloy layer is equal to or greater than 60%.

14. The method of claim 11, wherein the thermal treatment is performed at a temperature ranging from 200 to 500° C.

15. The Ni—Cu plated high-carbon steel wire of claim 5, wherein the thermal treatment is performed at a temperature ranging from 200 to 500° C.

16. The Ni—Cu plated high-carbon steel wire of claim 6, wherein the thermal treatment is performed at a temperature ranging from 200 to 500° C.

17. The method of claim 12, wherein the thermal treatment is performed at a temperature ranging from 200 to 500° C.

18. The method of claim 13, wherein the thermal treatment is performed at a temperature ranging from 200 to 500° C.
